(19) United States
(12) Patent Application Publication
(10) Pub. No.: US 2006/0077581 A1
(43) Pub. Date: Apr. 13, 2006

(54) Multipurpose optical imaging device, system and method

(76) Inventors: Jim Schwiegerling, Tucson, AZ (US); Jerome A. Legerton, San Diego, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 11/217,683

(22) Filed: Aug. 31, 2005

Related U.S. Application Data
(60) Provisional application No. 60/605,780, filed on Aug. 31, 2004.

(51) Int. Cl. G02B 7/00

(52) U.S. Cl. 359/894

(57) ABSTRACT

Certain embodiments include medical devices for capturing images of a localized portion of a body, such as the eye or skin tissue. An exemplary system utilizes a hand-held portable viewer. Various embodiments of the viewer have telecentric optics with a focal length of between about six inches and about twelve inches. The viewer also includes an image sensor adapted to capture an image of the object being studied, and may include one or more illumination sources selectively operable to illuminate the object. A light meter that measures a light level reflected from the object and a level that measures a rotational position of the viewer relative to a reference level position may be included. One or more filters may be removably fastenable to the viewer to cover the illumination source or sources and/or the aperture.

### CROSS-REFERENCE TO RELATED APPLICATIONS

This application claims priority to U.S. Provisional Application No. 60/605,780, filed Aug. 31, 2004 and titled “MULTIPURPOSE OPTICAL IMAGING SYSTEM,” the entire contents of which are hereby incorporated by reference and should be considered a part of this specification

### BACKGROUND

1. Field of the Invention

This invention relates to optical imaging systems, and more particularly to a multipurpose medical ocular imaging device, system and method, such as for ocular imaging.

2. Description of the Related Art

Doctors often use tools to examine localized parts of the human body, such as the eyes or a portion of the skin. One such device, a pupilometer, is disclosed in U.S. Pat. No. 6,820,979, issued to Stark et al. on Nov. 23, 2004.

With regard to optometrists and ophthalmologists, it is desirable to inspect the eyes and eye lids for at least one of various reasons. For example, it is desirable to examine the eyes for any lesions of the cornea, sclera, and conjunctiva. It is also desirable to examine the pupils of the eyes under scotopic, mesopic or photopic ambient conditions for the purpose of measuring their size and reactivity. This allows doctors to evaluate that treatment zones cover the pupil under different lighting conditions. It is also desirable to inspect contact lens registration marks in vivo relative to the pupil geometric center, which enables registering lenses over the entrance of the pupil or visual axis. It is also desirable to evaluate the presence of applied stains enabling the differential diagnosis of dry eye conditions, allergy inflammation and infection. Additionally, it is desirable to examine and evaluate fluorescein patterns of contact lenses in vivo to evaluate the fit of the contact lens or for assigning in a consultation between educators or manufacturers and fitters or doctors.

Thus, it is desirable to image the eye for various reasons.

### SUMMARY

In accordance with one embodiment, a medical viewer for capturing images of a localized portion of a patient's body is provided. The viewer comprises a hand-held housing having an optical aperture for receiving light therethrough, said hand-held housing including a handle for holding the housing when capturing images. The viewer also comprises imaging optics, said imaging optics being substantially telecentric. An imaging sensor is disposed in the housing with respect to said telecentric imaging optics such that optical images of said localized portion of the human body are formed on said image sensor and captured by said image sensor. The telecentric imaging optics has a focal length that is sufficiently short so as to provide a field-of-view less than about three inches wide but is sufficiently long such that focused images of the localized portion of the human body can be formed if said viewer is at least one inch from the patient's body.

In accordance with another embodiment, an optical viewer for capturing images of an eye is provided. The viewer comprises a hand-held housing having an optical aperture for receiving light therethrough, said hand-held housing including a handle for holding the housing when capturing images. The viewer also comprises imaging optics and an imaging sensor disposed in the housing with respect to imaging optics such that optical images of the eye are formed on said image sensor and captured by said image sensor. The viewer also comprises a built-in light meter that measures an ambient light level at the eye and storage for recording the measured light level.

In accordance with another embodiment, a medical viewer for capturing images of a part of the human body is provided. The viewer comprises a hand-held housing having an optical aperture for receiving light therethrough, said hand-held housing including a handle for holding the housing during image capture. The viewer also comprises imaging optics and an imaging sensor disposed in the housing with respect to imaging optics such that optical images are formed on said image sensor and captured by said image sensor. The viewer also comprises a level sensor configured to measure the orientation of the housing.

In accordance with another embodiment, a medical viewer for capturing images of a part of the human body is provided. The viewer comprises a hand-held housing having an optical aperture for receiving light therethrough, said hand-held housing including a handle for holding the housing during image capture. The viewer also comprises imaging optics and an imaging sensor disposed in the housing with respect to the imaging optics such that optical images of the part of the body are formed on said image sensor and captured by said image sensor. The viewer also comprises a plurality of illumination sources having different spectral responses, said illumination sources disposed so as to illuminate the part of the body to be imaged.

### BRIEF DESCRIPTION OF THE DRAWINGS

FIG. 1 is a schematic perspective view of one embodiment of a portable multipurpose ocular imager comprising an imaging sensor and imaging optics within a housing.

FIG. 2 is a schematic side view of the imager in FIG. 1.

FIG. 3 is a schematic rear view of the imager in FIG. 1 showing a display for displaying images.

FIG. 4 is a schematic front view of the imager in FIG. 1 showing an optical aperture through which light enters the viewer.

FIG. 5 is a schematic front view of a filter for use with the imager in FIG. 1.

FIG. 6 is a schematic front view of the imager in FIG. 1 with the filter of FIG. 5 attached thereto.

FIG. 7A is a schematic view of one embodiment of a multipurpose ocular imaging system in communication with a computer system via a wireless interconnect.

FIG. 7B is a schematic view of another embodiment of a multipurpose ocular imaging system that fits into a cradle for interfacing with a computer.

FIG. 8 is a flowchart of one embodiment of an optical imaging method.

### DETAILED DESCRIPTION OF CERTAIN PREFERRED EMBODIMENTS

In the following detailed description, terms of orientation such as “upper,” “lower,” “front,” “rear,” and “end” are used to simplify the description of the context of the illustrated embodiments. Likewise, terms of sequence, such as “first” and “second,” are used to simplify the description of the illustrated embodiments. Because other orientations and sequences are possible, however, the present invention should not be limited to the illustrated orientation. Those skilled in the art will appreciate that other orientations of the various components described above are possible. In addition, “ocular imaging device,” “optical imaging device” and “viewer” are used interchangeably.

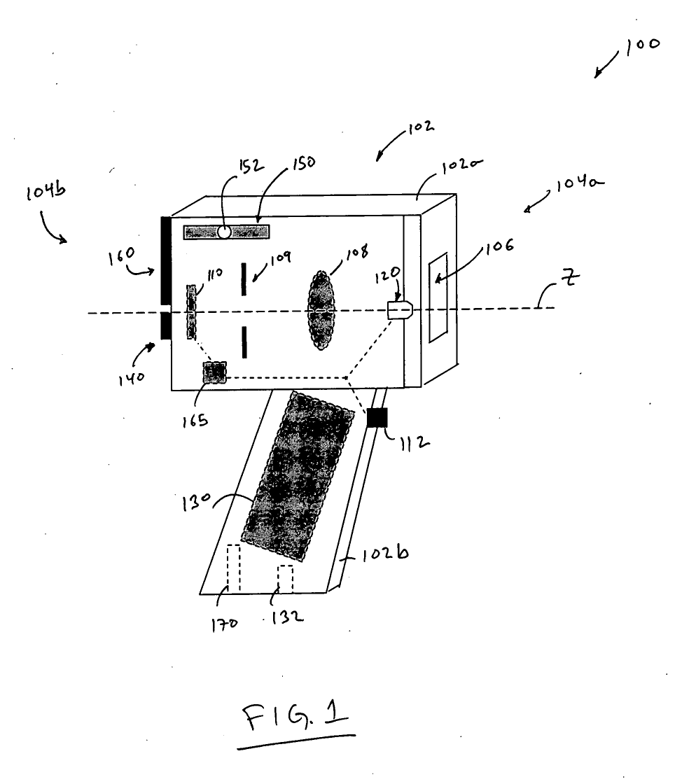

FIGS. 1-6 illustrate one embodiment of a multipurpose ocular or optical imaging device or viewer 100. The viewer 100 comprises a housing 102 having an upper portion or main body 102a and a lower portion or handle 102b. The upper portion 102a preferably extends from a front end 104a to a rear end 104b. In the illustrated embodiment, the lower portion 102b is a hand grip, which can be used by a user to support the viewer 100. In one embodiment, the upper portion 102a has a length of between about three inches and about five inches. Additionally, in one embodiment, the upper portion 102a can have an average width or effective diameter of between about 1.5 inches and about three inches. However, the main body 102a can have any suitable dimensions. Moreover, though the schematic illustration depicts the upper portion 102a and lower portion 102b as having a generally rectangular cross-section, other suitable shapes can be used, such as round and oval, or taper from the front end 104a to the back end 104b. Corners may also be rounded. The housing 102 may be smoothly contoured. In one embodiment, the housing 102 has a shape similar to that of a compact hair dryer. In various preferred embodiments, the viewer 100 is a hand-held, light-weight, portable device that can be held and manipulated by hand during alignment and image capture.

The viewer 100 preferably has a window or optical aperture 106 on the front end 104a which may a material that is substantially optically transmissive to allow light to pass into the viewer 100. Imaging optics 108 is disposed in the viewer 100. In various preferred embodiments, the imaging optics 108 is disposed along an optical path that includes the window 106 and receives the light passing through the aperture. In various preferred embodiments, the imaging optics 108 has a variable focal length and zoom capability although the focal length may be fixed. In one embodiment, the imaging optics 108 has a focal length of between about six inches and about twelve inches. However, in another embodiment, the lens 108 can have a focal length of less than about six inches. In some embodiments, the focal length is less than nine or eight inches and may be between four and eight inches or five and seven inches or about six inches. Other focal lengths are possible. The longitudinal distance along the optical (Z) axis between the optical aperture 106 and the imaging optics 108 may be between about zero and three inches in some embodiments. The imaging optics 108 may be between about 0.25 inch and 1 inch in thickness in some embodiments. Values outside these ranges, however, are possible.

In certain embodiments, the imaging optics 108 provides a field-of-view of between about one-half inch to about three inches. Advantageously, a field-of-view of about one-half inch allows the adequate examination of a cornea of an eye. Likewise, a field-of-view of about one inch allows the adequate examination of an eye such that scars on the eye are visible. Accordingly the field-of-view may be less than one or two inches in some embodiments. The angular field-of-view may range, for example, between about 9 degrees and 27 degrees. Other field-of-views are also possible.

As shown in FIG. 1, a stop 109 may be disposed on the image side of the imaging optics 108. In various embodiments, the stop is disposed at or near the rear focus of the imaging optics 108 and is thus separated by the imaging optics by about one focal length As is well know, placement of the stop 109 at the rear focal plane of the imaging optics 108 provides telecentricity. In particular, the optics 108 is substantially telecentric in object space. As a result, image magnification remains generally constant even if the image is out of focus. Such a feature is advantageous as size measurements will remain substantially accurate even if the image is out of focus, for example, because of slight movement or unsteadiness of the hand when holding the viewer during image capture. In one embodiment, the telecentric imaging optics 108 has a focal length sufficiently long such that images of the localized portion of the human body can be formed if the viewer 100 is more than one inch from the patient's body. In another embodiment, the telecentric imaging optics 108 has a focal length sufficiently long such that images of the localized portion of the human body can be formed if the viewer 100 is more than two inches, or more than three inches, from the patient's body. In some embodiments, the telecentric imaging optics 108 has a focal length that is sufficiently long such that focused images of the localized portion of the human body cannot be formed if said viewer contacts the patient's body.

The viewer 100 also comprises an image sensor 110 adapted to capture images formed thereon. As shown in FIG. 1, the imaging sensor is disposed in the main body 102a. In particular, the image sensor 110 in the optical path that includes the aperture 106, the stop 109, and the image optics 108. As shown, the optical axis (Z-axis) passes through these elements. The aperture stop 109 is between the imaging optics 108 and imaging sensor 110. The imaging sensor 110 is disposed in the image plane of the imaging optics such that objects to be imaged by the viewer 100 appear on the image sensor 110 to be captured by the image sensor 110. In various embodiments, the image sensor 110 is between about 1 inch and 2.5 inches from the imaging optics. In various preferred embodiments, the image sensor 110 comprises a detector array such as a CCD array. In another embodiment, the image sensor 110 is a CMOS detector array. However, the image sensor 110 may comprise other suitable types of optical detectors.

In various embodiments the viewer 100 may have a work distance of between about 2 inches and 4 inches such that the viewer 100 can be positioned such a distance from the patient. In certain preferred embodiments, the viewer 100 does not contact the patient when images are in focus on the imaging sensor 110. Accordingly, the viewer does not need to contact the patient's body when images are captured. Sterilization procedures are therefore advantageously not necessary. Likewise, enhanced patient comfort is provided since no contact with the patient is required. In various embodiments, the focal length and resultant work distance are sufficiently long such that the images are out of focus when the viewer is contacted to the patient's body. Likewise, in various preferred embodiments, the viewer does not include a cuff or baffle that extends to and contacts the patient when images are to be captured.

In various embodiments, the image sensor 110 is selectively operable to capture both streaming video (e.g., NTSC) and high resolution still image frames. In one embodiment, the image sensor 110 is adapted to capture about fifteen seconds of streaming video. Support circuitry may be provided to still image capture and video.

As shown, for example, in FIG. 1, an actuator or trigger 112 is disposed on the lower portion or handle 102b of the housing 102. The trigger 112 is operatively coupled to the image sensor 110 and is adapted to actuate the capture of an image onto the sensor 110. For example, in one embodiment the trigger 112 can be a button that is depressed by a user to actuate the capture of an image. However, the trigger 112 can have other suitable configurations.

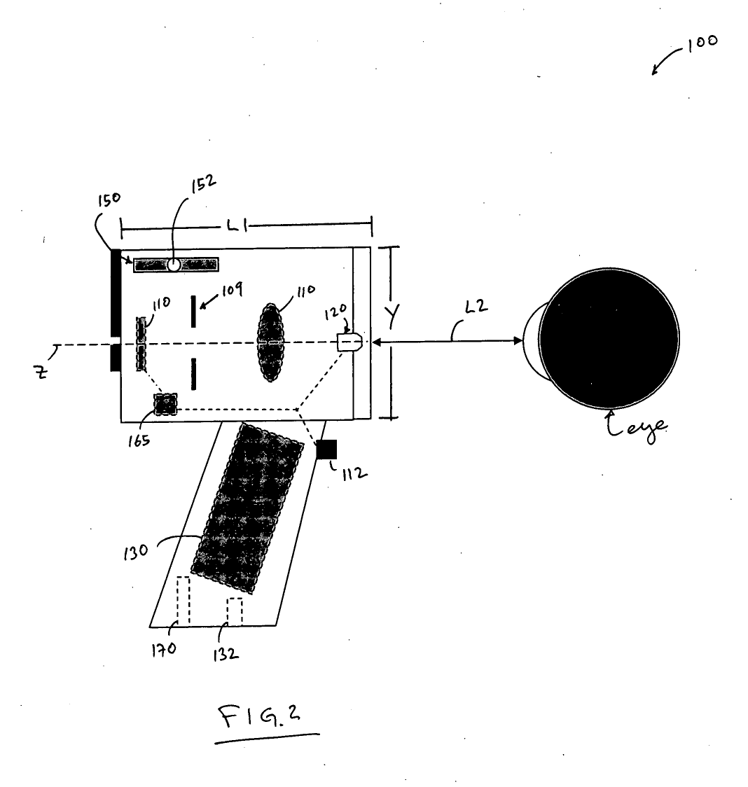

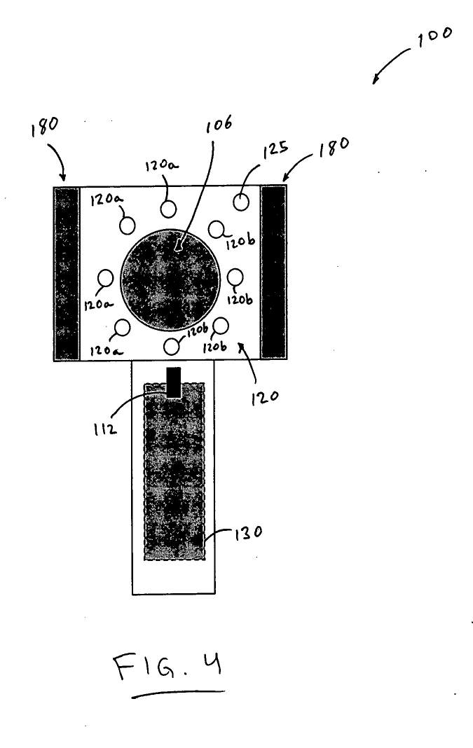

As shown in the embodiment illustrated in FIG. 1, the viewer 100 also preferably comprises at least one illumination source 120 disposed at the front end 104a of the main body 102a possibly on a front face of the viewer. The illumination source 120 preferably selectively illuminates an object of interest, such as the eye shown on FIG. 2, as further discussed below. In one embodiment, the at least one illumination source 120 includes a plurality of illumination sources 120 having different spectral responses. For example, the plurality of illumination sources 120 can include at least one white light source 120a and at least one infrared source 120b, wherein at least one of the sources 120 is selectively actuatable to illuminate the object of interest. In the embodiment illustrated in FIG. 4, eight illumination sources 120 are shown, disposed about the circumference of the aperture 106. Although eight illumination sources 120 are shown, a smaller or greater number of illumination sources can be provided, and they can be arranged in any desired configuration, such as circumferentially about the aperture 106. In one embodiment, three or more illumination sources 120 are disposed about a circumference of the optical aperture 106. In another embodiment, four or more illumination sources 120 are disposed about the circumference of the optical aperture 106. In one embodiment, the illumination source 120 is adapted to generate at least one of infrared, blue and white light. For example, a white light source and an infrared source may be provided. In another embodiment, the illumination source 120 can include a plurality of colored LEDs (e.g. red, green, and blue), which are preferably operable to provide a desired illumination color. In one embodiment, the illumination source 120 includes a white light LED. In another embodiment, the illumination source 120 includes an infrared LED, which advantageously can be used to capture images in the dark such that the eye pupil remains dilated during measurement and/or image capture. The imaging sensor 110 may be sensitive to infrared. In one embodiment, the illumination source 120 can include a white light bulb. However, the illumination source 120 can be other suitable types. Accordingly, the object of interest, such as the eye in FIG. 2, can be examined under a variety of lighting conditions, including ambient light and darkness. In another embodiment, the viewer 100 utilizes ambient lighting and does not have any illumination sources 120. In one embodiment, one or more of the illumination sources, such as an infrared LED and/or white light LED can be placed inside the instrument and projected along the optic axis. A beam splitter or mirror may be used in some cases to couple the light into the optical path along the optical axis. The light sources 120 can otherwise be included in the housing as well.

As shown in FIG. 4, a light meter 125 is preferably disposed at a different location than the image sensor 110. In one embodiment, the light meter 125 is disposed at the front end 104a of the viewer 100, possibly on the front face or surface. In one embodiment, the light meter 125 is preferably proximal the illumination sources 120. In one embodiment, the light meter 125 measures an ambient light level at the object of interest, for example, or elsewhere. during the capture of the image. In various embodiments, the light meter 125 measures the luminance reflected from the object of interest (e.g., from the eye). In another embodiment, the light meter 125 can measure an illuminance from the object of interest. The light meter 125 may comprise an optical detector and collection optics (e.g., a lens and/or diffuser) although other configurations are possible. In one preferred embodiment, the light meter 125 is sensitive to infrared wavelengths. Preferably, the light meter 125 communicates said measurement to a controller or other circuitry, as discussed further below. In some embodiments, the light meter can be placed inside the instrument and may, e.g., extract some light propagating along the optical path to the imaging sensor 110. A beam splitter may be used in some cases to couple a portion of light out of the optical path. The light sources 120 can otherwise be included in the housing as well. In other embodiments, the illumination can be averaged over the image sensor 110 to obtain a measurement of the light level, e.g., at the object of interest.

In a preferred embodiment, the viewer 100 is portable and is powered by a battery 130, such as a rechargeable battery. Preferably, the battery 130 provides power to the image sensor 110, the illumination source 120 and other components, as discussed further below. As shown in FIG. 1, the viewer 100 can also be powered via a connection jack 132. In one embodiment, the battery 130 can be re-charged via the jack 132. In another embodiment, a DC source can be connected to the viewer 100 via the jack 132 to provide power to the viewer 100.

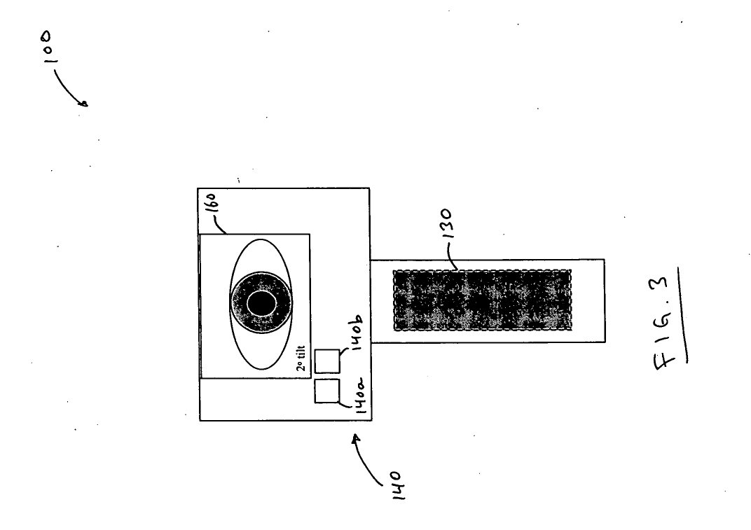

As best shown in FIG. 3, the viewer 100 includes at least one operational switch 140 disposed on the rear end 104b of the main body portion 102a. However, the at least one switch 140 can be disposed in other suitable locations on the viewer 100, such as locations easily accessed by a user. In the illustrated embodiment, two operation switches 140a, 140b are shown. However, it will be obvious to one of ordinary skill in the art that more than two operational switches 140 can be provided. In one preferred embodiment, one operation switch 140a selects the operation mode of the image sensor 110. For example, the operation switch 140a can select the operation of the image sensor 110 between streaming video and high resolution still image frames. In another preferred embodiment, one operational switch 140b selectively operates the illumination source 120 to illuminate the object of interest. For example, the switch 140b can be actuated to select the operation of an infrared LED. In another example, the switch 140b can be actuated to select the operation of a white light LED. In still another example, the switch 140b can be actuated to sequentially operate illumination sources 120 disposed about the aperture 106. In another embodiment, the operational switch 140 can be used to select the desired focal length for capturing images.

With reference back to FIG. 1, the viewer 100 preferably comprises a level 150 adapted to sense a rotational position of the viewer 100 about a longitudinal axis Z extending through the main body portion 102a. In one embodiment, the level 150 senses a rotational position of the viewer 100 relative to a reference level position. In the illustrated embodiment, the longitudinal axis Z is an optical axis. In one embodiment, the reference level position is a position where the lower portion 102b extends downward and generally orthogonal to the earth's surface. In one embodiment, the level 150 is an electronic level. Examples include a CXTLA01 tilt sensor from Crossbow Technology, Inc. or an inclinometer from US Digital Corporation of Vancouver, Wash. In another embodiment, the level 150 can include a bubble disposed in a liquid, as known in the art. In another embodiment, the level 150 includes a level indicator 152 that allows for image capture when the viewer 100 is in the reference level position. In one embodiment, the level indicator 152 is a light or other visual indicator that illuminates when the viewer 100 is in the reference level position. In another embodiment, the level indicator 152 is a switch that communicates with the actuator 112 and/or the image sensor 110 when the viewer 100 is in the reference level position. In another embodiment, the level 150 communicates the sensed rotational position of the viewer 100 to a controller or control and/or image acquisition circuitry, as further discussed below.

In one embodiment, the viewer 100 also comprises a display 160, as best shown in FIGS. 1 and 3. In the illustrated embodiment, the display 160 is disposed on the rear end 104b of the head portion 102a. However, the display 160 can be disposed at other suitable locations. In one preferred embodiment, the display 160 is an LCD. Other types of displays may also be employed. The display 160 preferably displays the image of the object of interest prior to capture, as well as images of the object during and after capture. For example, as shown in FIG. 3, where the object of interest is a human eye, the display 160 can illustrate the portion of the eye being examined. In one embodiment, the display 160 also displays the rotational position of the viewer, as shown in FIG. 3. Likewise, the display 160 can also preferably display the light level (e.g. luminance) measured by the light meter 125 and a date and time of image capture. The noted display fields shown in FIG. 3 are of course merely exemplary of the type of fields and information displayed on the display 160.

As discussed above, the viewer 100 also preferably comprises a controller or control circuitry 165. In one embodiment, the controller 165 is a programmable microprocessor. In another embodiment, the controller 165 communicates with the image sensor 110, the actuator 112, the illumination sources 120, the light meter 125, the level 150, the display 160 and the battery 130. In one embodiment, the controller 165 includes an electronic clock to provide the date and time. The controller 165 preferably communicates captured images, as well as the measured luminance, the sensed level position, and the date and time of image capture to memory or storage or a desired receiver, as further discussed below. In a preferred embodiment, the controller 165 and/or acquisition and image transfer circuitry communicates the information above via a wireless (e.g., RF or optical) connection. In another embodiment, the controller 165 communicates information via a hardwired connection. In one embodiment, the controller 165 communicates information to a desired receiver via a USB port 170, as shown in FIG. 1. Memory storage devices such as flash memory, ROM/BIOS, hard drives, removable drives, and memory sticks can be used for convenient storage of images, video, or other data recorded such as time and date, light level, viewer 100 orientation, text, etc.

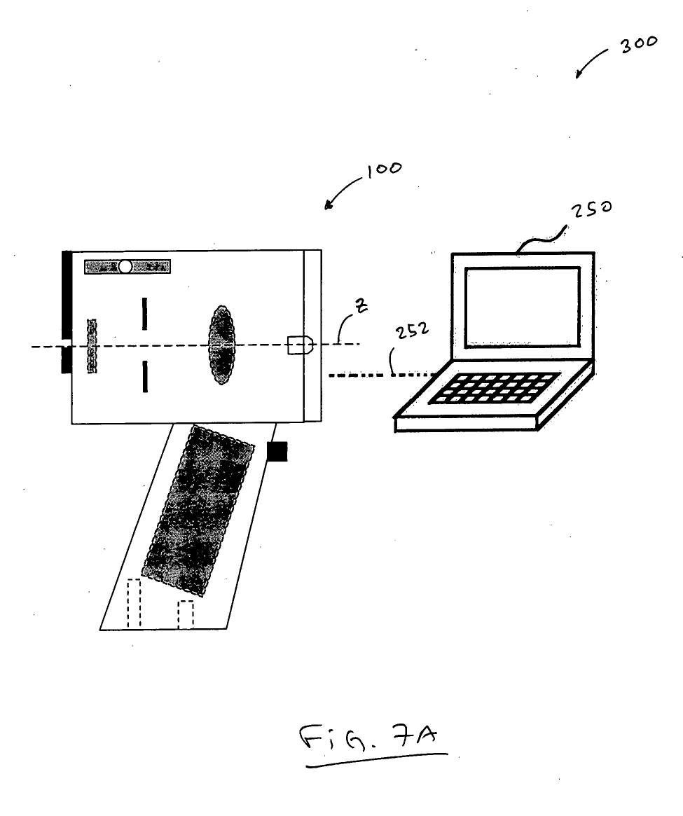

With reference to FIGS. 4 and 6, the viewer 100 includes a filter holder 180 on the front end 104a of the viewer 100. In one embodiment, the filter holder 180 includes slots on the front end 104a, into which a filter 200 can be removably disposed. Alternatively, springs, clips, snaps, screws, bolts, nuts, latches, levers, hooks, magnets, pins, can be used. However, the filter holder 180 can comprise other mechanisms for fastening or securing the filter 200 to the viewer 100.

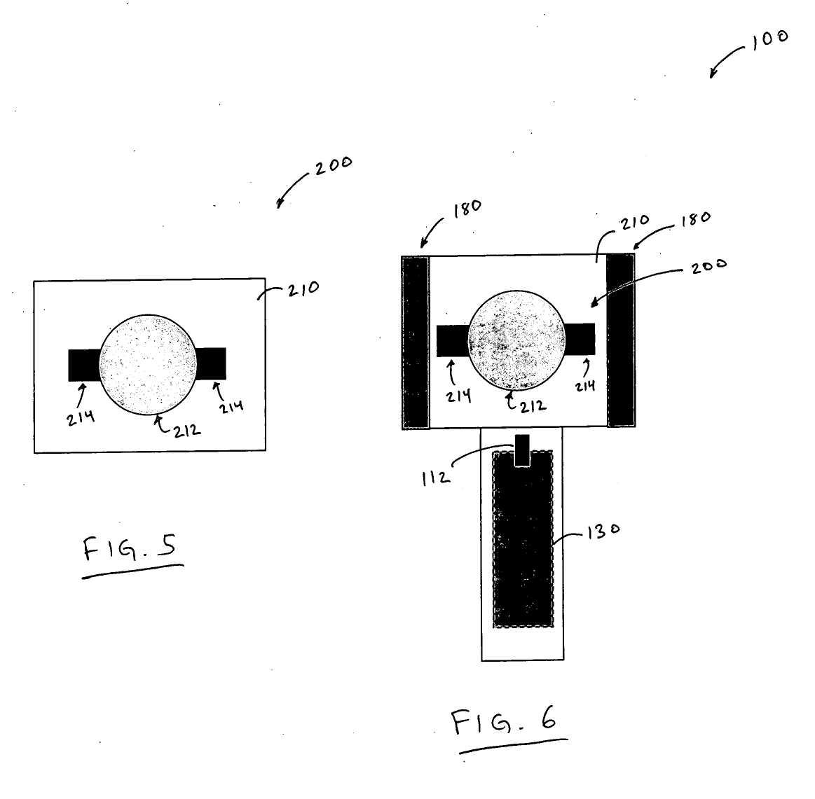

The filter 200 is preferably disposed on the viewer 100. In one embodiment, as shown in FIG. 5, the filter 200 includes a filter plate 210, a barrier filter 212 and an excitation filter 214. The barrier filter 212 is preferably disposed in front of, and substantially covers, the window or optical aperture 106, and the excitation filter 214 is preferably disposed in front of, and substantially covers, the illumination source 120. Preferably, the filter 200 filters out a desired wavelength of light. In one embodiment, the barrier filter 212 is a Wratten Yellow filter. In another embodiment, the excitation filter is a Cobalt Blue filter. Blue light may excite fluorescein dye causing green color light to be emitted. Accordingly, in one embodiment the filter 200 is adapted for fluorescence imaging, and can be used, for example, in conjunction with the application of fluorescein dye to a human eye to be examined with the viewer 100. However, the filter 200 can be used with other fluorescent dyes, such as Rose Bengal and Lysamine Green, and the appropriate excitation filter can be used for illumination and the appropriate barrier filter is used in the imaging channel.

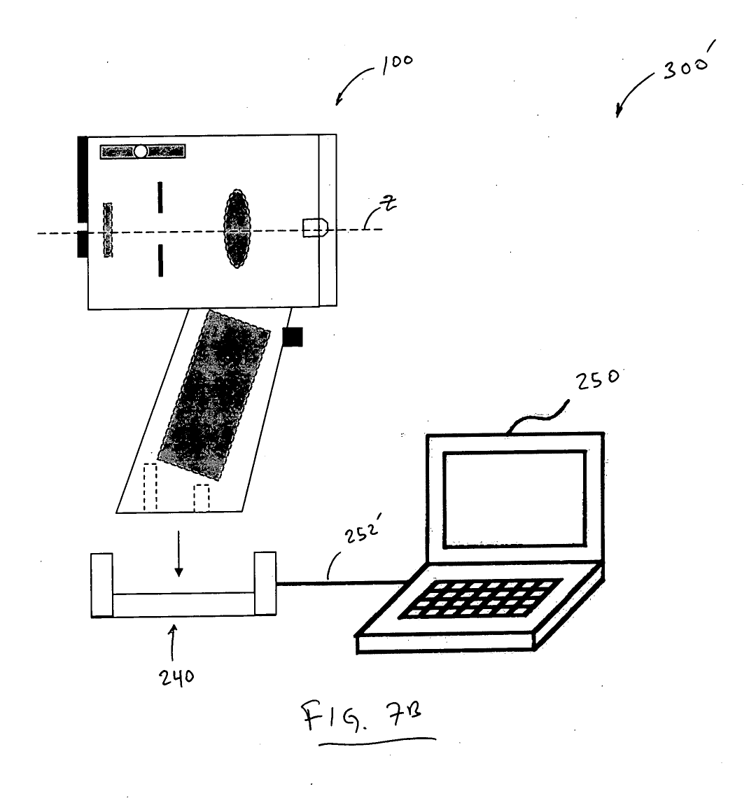

FIG. 7A illustrates one embodiment of a multipurpose ocular imaging system 300. The system 300 preferably comprises the viewer 100, as described above, and a computer 250. In the illustrated embodiment, the viewer 100 communicates with the computer 250 via a wireless connection 252. Preferably, the computer is outfitted with software adapted to receive the captured images from the viewer 100, as well as measure, process, and/or archive the captured images. Additionally, the computer 250 preferably facilitates the exportation of said captured images to, for example, a printer, fax, via the internet or e-mail, CD, memory stick, etc. The computer 250 additionally is adapted to export measurement values related to captured images of an eye to, for example, a lens order form for printing, faxing, emailing, and transferring via the Internet. In one preferred embodiment, the computer 250 has software adapted to correct the orientation of captured images based on the orientation measurement, e.g., of the rotational position about the optical axis, taken by the level 150. For example, in one embodiment, where the error is introduced by a clockwise rotation of the viewer 100 during image capture, the computer 250 can counter-rotate the image in a counterclockwise manner to reorient the captured image as if it had been captured at a level position. Similarly, if the viewer is rotated counter-clockwise with respect to a level position, the images may be rotated clockwise. Though the system 300 in the illustrated embodiment utilizes a computer 250, other suitable computational systems and devices can be used, such as a PDA, networks, etc.

FIG. 7B illustrates another embodiment of a multipurpose ocular imaging system 300′, also comprises the viewer 100 and a computer 250′. In the illustrated embodiment, the viewer 100 can be removably coupled to a docking station 240, which communicates with the computer 250′ via a hardwired connection 252′. Accordingly, the viewer 100 can thus transfer the captured images and measurements, as discussed above, to the computer 250′ via the docking station 240. In other embodiments, the docking station 240 may communicate with the computer 250′ via wireless transmissions.

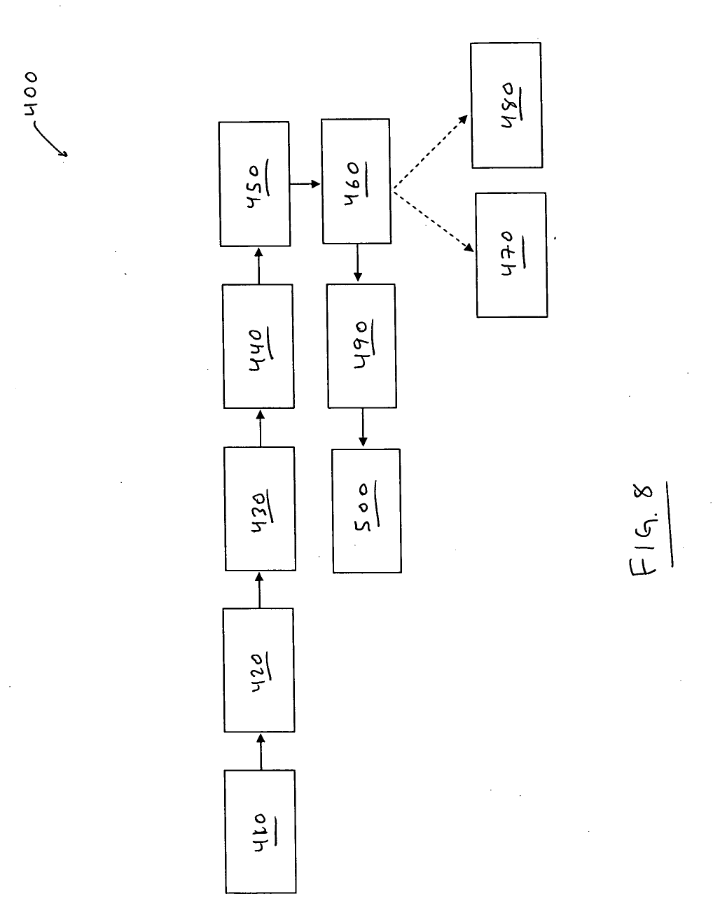

The operation of a multipurpose ocular imaging system will now be described. A method 400 for ocular imaging of an eye is illustrated in FIG. 8. In the illustrated embodiment, the method 400 includes providing 410 a multipurpose portable ocular viewer, such as the viewer 100 described above. A user then selects 420 a desired illumination source 120, such as by using the switch 140b, if used. A user may optionally select 430 the desired focal length for capturing an image of the eye. The method also includes the step of selecting 440 the desired image capture mode, such as selecting between streaming video and still image frame capture via the switch 140a. A user would then point 450 the viewer 100 at a desired site (e.g. eye) and actuate 460 the image capture of said eye, such as by actuating the trigger 112. Preferably, the user would hold the viewer 100 at a desired distance L2 from the eye, as shown in FIG. 2. In one embodiment said distance is about 75 mm. However, in another embodiment, the distance is less than 75 mm. Advantageously, the viewer 100 does not require a cuff to set the required distance from the eye at which the viewer 100 is to be held or to block out ambient light. Therefore, the operation of the viewer 100 is not limited to a particular work distance. The viewer 100 instead can be operated over a range of work distances from the eye, including a distance proximal the front end 104a of the viewer 100, and allows ambient light to illuminate the eye. Moreover, the viewed need not contact the patient reducing sterilization and cleaning requirements and does not interfere with the patient and thus may be a more comfortable non-intrusive procedure.

In one embodiment, actuating the image capture includes measuring 470 a rotational orientation of the eye and measuring 480 a luminance of the eye. The method also includes the step of transferring 490 the captured image to desired receiver, such as the computer 250. In one embodiment, the captured image is automatically transferred to the desired receiver upon actuation. In another embodiment, the method also includes the step of adjusting 500, an orientation of the captured image, to correct an error corresponding to the difference between the measured rotational orientation and a reference level orientation/position.

The methods used can vary widely. For example, additional steps may be added. Other steps may be removed or executed differently. Also the order may vary. Other variations are also possible.

In one embodiment, for example, the viewer 100 can advantageously be operated as a keratometer to examine the curvature of the cornea. Accordingly, the viewer 100 can be used to measure corneal astigmatism. For example, the switch 140b can be set to operate three or more illumination sources 120 disposed about the circumference of the aperture 106 in a sequential manner. Accordingly, the illumination ring projected onto the eye by the illumination sources 120, and the corresponding reflection captured by the image sensor 110, can be used to measure the curvature of the cornea, and to check for corneal astigmatism and meridional irregularity of the cornea. In various embodiments the magnification of the reflected image of the ring of illumination sources from the surface of the cornea assists in determining the shape of the cornea. The viewer can advantageously be operated as a radiuscope to, in the same manner, determine the curvature and shape of a concave or convex surface of a contact lens or other lens. Still other variations are possible.

The viewer 100, system 300, 300′ and method 400 discussed above advantageously provide practitioners with a versatile ocular imaging system. For example, the viewer 100 allows ophthalmologists and plastic surgeons to examine lesions of the cornea, sclera, and, conjunctiva. The viewer enables convenient examination of the eye and eye lids for medical diagnosis, monitoring, and documentation. Additionally, the viewer 100 allows ophthalmologists and other practitioners to examine the pupil of an eye under scotopic, mesopic or photopic ambient conditions to measure pupil size, which is facilitated by the telecentric optics in the viewer 100. Additionally, refractive surgeons can use the viewer 100 to ensure treatment zones cover the pupil under different lighting conditions. Additionally, the viewer 100 can be used for drug screening to document pupillary response. The viewer 100 also allows practitioners in the fitting of contact lenses by examining contact lens registration marks in vivo relative to the pupil geometric center to enable registering lenses over the entrance pupil or visual axis. Accordingly, the viewer 100 is useful to optometrists in fitting rigid gas permeable and toric lenses. For example, the viewer 100 can be used to image toric contact lenses to determine their orientation on an eye. Additionally, the viewer 100 can be used to determine the translational and orientational registration error of a multi-focal contact lens using the level 150. Further, the viewer 100 advantageously aids optometrists and other eye-care practitioners, as well as manufacturers, to examine fluorescein patterns of lenses in vivo to evaluate the fit of contact lenses.

Though the embodiments above are discussed in relation to the imaging of an eye, one of ordinary skill in the art will recognize that the device, system and methods described above can be used to examine other objects of interest, such as human skin tissue. For example, a dermatologist may use the viewer 100 to examine lesions on a patient's skin under controlled illumination conditions.

Although this invention has been disclosed in the context of a certain preferred embodiment and examples, it will be understood by those skilled in the art that the present invention extends beyond the specifically disclosed embodiments to other alternative embodiments and/or uses of the invention and obvious modifications and equivalents thereof. In addition, while a number of variations of the invention have been shown and described in detail, other modifications, which are within the scope of this invention, will be readily apparent to those of skill in the art based upon this disclosure. It is also contemplated that various combinations or subcombinations of the specific features and aspects of the embodiments may be made and still fall within the scope of the invention. Accordingly, it should be understood that various features and aspects of the disclosed embodiments can be combined with or substituted for one another in order to form varying modes of the disclosed invention. Further, by listing method steps in a particular order within a claim, no intention is made to limit the scope of the claim to that particular order. Thus, it is intended that the scope of the present invention herein disclosed should not be limited by the particular disclosed embodiments described above, but should be determined only by a fair reading of the claims that follow.

What is claimed is:

1. A medical viewer for capturing images of a localized portion of a patient's body, said viewer comprising:
a hand-held housing having an optical aperture for receiving light therethrough, said hand-held housing including a handle for holding the housing when capturing images;
imaging optics, said imaging optics being substantially telecentric;
an imaging sensor disposed in the housing with respect to said telecentric imaging optics such that optical images of said localized portion of the human body are formed on said image sensor and captured by said image sensor;
wherein said telecentric imaging optics has a focal length that is sufficiently short so as to provide a field-of-view less than about three inches wide but is sufficiently long such that focused images of the localized portion of the human body can be formed if said viewer is at least one inch from the patient's body.

2. The viewer of claim 1, wherein said telecentric imaging optics has a focal length that is sufficiently long such that focused images of the localized portion of the human body cannot be formed if said viewer contacts the patient's body.

3. The viewer of claim 1, wherein said telecentric imaging optics has a focal length that is sufficiently long such that focused images of the localized portion of the human body can be formed if said viewer is at least two inches from the patient's body.

4. The viewer of claim 1, wherein said telecentric imaging optics has a focal length that is sufficiently long such that focused images of the localized portion of the human body can be formed if said viewer is at least three inches from the patient's body.

5. The viewer of claim 1, wherein the focal length is less than about twelve inches.

6. The viewer of claim 5, wherein the focal length is less than about nine inches.

7. The viewer of claim 6, wherein the focal length is less than about six inches.

8. The viewer of claim 1, wherein the focal length is between about six inches and about twelve inches.

9. The viewer of claim 1, wherein the imaging optics has a field-of-view of about two inches or less.

10. The viewer of claim 9, wherein the imaging optics has a field-of-view of about one inch or less.

11. The viewer of claim 1, wherein the imaging optics has a field-of-view of between about one-half inch and about three inches.

12. The viewer of claim 1, wherein the imaging optics has an angular field-of-view less than about 27 degrees.

13. The viewer of claim 1, further comprising at least one illumination source disposed to illuminate the portion of the body to be imaged.

14. The viewer of claim 13, wherein the at least one illumination source includes a plurality of illumination sources having different spectral responses.

15. The viewer of claim 13, wherein the at least one illumination source includes a white light LED.

16. The viewer of claim 13, wherein the at least one illumination source includes an infrared LED.

17. The viewer of claim 13, wherein the at least one illumination source includes at least three illumination sources disposed about a circumference of the optical aperture.

18. The viewer of claim 13, further comprising at least one filter removably disposed so as to cover the optical aperture and the at least one illumination source.

19. The viewer of claim 18, wherein the at least one filter is adapted for fluorescence imaging.

20. The viewer of claim 19, wherein the at least one filter includes a cobalt blue filter disposed over the illumination source and a Wratten yellow filter disposed over the optical aperture.

21. The viewer of claim 1, further comprising an actuator adapted to actuate the capture of the image on the image sensor.

22. The viewer of claim 21, wherein the actuator comprises a trigger on said handle.

23. The viewer of claim 21, wherein the actuator is adapted to actuate the operation of at least one illumination source disposed to illuminate said localized portion of the human body.

24. The viewer of claim 1, further comprising a built-in light meter that measures an ambient light level at the portion of the body to be imaged.

25. The viewer of claim 1, further comprising a level sensor configured to measure the orientation of the housing.

26. The viewer of claim 1, further comprising a display disposed on the housing, the display adapted to display at least one of the images captured by the image sensor.

27. The viewer of claim 1, further comprising image transfer circuitry disposed in the housing and configured to communicate the captured image in to a receiver.

28. The viewer of claim 27, wherein the image transfer circuitry comprises a microprocessor.

29. The viewer of claim 27, wherein the image transfer circuitry comprises an RF or optical transmitter that communicates via a wireless communication.

30. The viewer of claim 1, wherein the localized portion of the body is an eye pupil and wherein the viewer comprises a pupilometer configured to measure the eye pupil.

31. A optical viewer for capturing images of an eye, comprising:
a hand-held housing having an optical aperture for receiving light therethrough, said hand-held housing including a handle for holding the housing when capturing images;
imaging optics;
an imaging sensor disposed in the housing with respect to said imaging optics such that optical images of the eye are formed on said image sensor and captured by said image sensor;
a built-in light meter that measures an ambient light level; and
storage for recording the measured light level.

32. The viewer of claim 31, wherein the imaging optics is substantially telecentric.

33. The viewer of claim 31, wherein the imaging optics has a focal length less than about twelve inches.

34. The viewer of claim 31, wherein the imaging optics has a focal length of between about five to seven inches.

35. The viewer of claim 31, wherein the imaging optics has a field-of-view of less than about three inches.

36. The viewer of claim 35, wherein the field-of-view is between about one-half inch and about three inches.

37. The viewer of claim 31, wherein the light meter measures luminance at the eye.

38. The viewer of claim 31, wherein the light meter is disposed at a different location from the image sensor.

39. The viewer of claim 31, further comprising at least one illumination source disposed so as to illuminate the eye to be imaged.

40. The viewer of claim 39, wherein the at least one illumination source includes a plurality of illumination sources having different spectral responses.

41. The viewer of claim 39, wherein the at least one illumination source includes a white light source.

42. The viewer of claim 39, wherein the at least one illumination source includes an infrared source.

43. The viewer of claim 39, wherein the at least one illumination source includes four or more illumination sources disposed about a circumference of the optical aperture.

44. The viewer of claim 39, further comprising at least one filter removably disposed so as to cover the optical aperture and the at least one illumination source.

45. The viewer of claim 44, wherein the at least one filter includes at least one color filter removably fastenable to the housing to cover at least one of the illumination sources to alter the spectral response, and at least one color filter removably fastenable to the housing to cover the optical aperture.

46. The viewer of claim 44, wherein the at least one filter is adapted for fluorescence imaging.

47. The viewer of claim 46, wherein the at least one filter includes a cobalt blue filter disposed over the illumination source and a Wratten yellow filter disposed over the optical aperture.

48. The viewer of claim 31, further comprising a level sensor configured to measure the orientation of the housing.

49. The viewer of claim 31, further comprising image transfer electronics configured to communicate the captured image to a receiver outside the housing.

50. A medical viewer for capturing images of a part of the human body, comprising:
a hand-held housing having an optical aperture for receiving light therethrough, said hand-held housing including a handle for holding the housing during image capture;
imaging optics;
an imaging sensor disposed in the housing with respect to said imaging optics such that optical images are formed on said image sensor and captured by said image sensor; and
a level sensor configured to measure the orientation of the housing.

51. The viewer of claim 50, wherein the level sensor is an inclinometer.

52. The viewer of claim 50, further comprising a storage device electrically connected to said level sensor for recording said measured orientation.

53. The viewer of claim 50, further comprising a processor for processing captured images so as to rotate said images based on measurements obtained from said level sensor.

54. The viewer of claim 50, wherein the level sensor measures the rotational position of the housing about an optical axis through the imaging optics.

55. The viewer of claim 50, wherein the imaging optics is substantially telecentric.

56. The viewer of claim 50, wherein the imaging optics has a focal length less than about twelve inches.

57. The viewer of claim 50, wherein the imaging optics has a focal length of between about four to eight inches.

58. The viewer of claim 50, wherein the imaging optics has a field-of-view of less than about three inches.

59. The viewer of claim 58, wherein the field-of-view is between about one-half inch and about two inches.

60. The viewer of claim 50, further comprising at least one illumination source disposed so as to illuminate the eye to be imaged.

61. The viewer of claim 60, wherein the at least one illumination source includes a plurality of illumination sources having different spectral responses.

62. The viewer of claim 60, wherein the at least one illumination source includes a white light LED.

63. The viewer of claim 60, wherein the at least one illumination source includes an infrared LED.

64. The viewer of claim 60, wherein the at least one illumination source includes three or more illumination sources disposed about a circumference of the optical aperture.

65. The viewer of claim 60, further comprising at least one filter removably disposed so as to cover the optical aperture and the at least one illumination source.

66. The viewer of claim 65, wherein the at least one filter includes at least one color filter removably fastenable to the housing to cover at least one of the illumination sources to alter the spectral response, and at least one color filter removably fastenable to the housing to cover the optical aperture.

67. The viewer of claim 65, wherein the at least one filter is adapted for fluorescence imaging.

68. The viewer of claim 67, wherein the at least one filter includes a cobalt blue filter disposed over the illumination source and a Wratten yellow filter disposed over the optical aperture.

69. The viewer of claim 50, further comprising an image transfer circuitry configured to communicate the image captured by the image sensor in a wireless manner.

70. The viewer of claim 50, wherein the part of the body is a human eye, and further comprising a built-in light meter adapted to measure an ambient light level at the eye.

71. The viewer of claim 70, wherein the light meter measures luminance from the eye.

72. The viewer of claim 70, wherein the light meter measures illuminance from the eye.

73. A medical viewer for capturing images of a part of the human body, comprising:
a hand-held housing having an optical aperture for receiving light therethrough, said hand-held housing including a handle for holding the housing during image capture;
imaging optics;
an imaging sensor disposed in the housing with respect to said imaging optics such that optical images of the part of the body are formed on said image sensor and captured by said image sensor; and
a plurality of illumination sources having different spectral responses, said illumination sources disposed so as to illuminate the part of the body to be imaged.

74. The viewer of claim 73, wherein the imaging optics is substantially telecentric.

75. The viewer of claim 73, wherein the imaging optics has a focal length less than about twelve inches.

76. The viewer of claim 73, wherein the imaging optics has a focal length of between about four to seven inches.

77. The viewer of claim 73, wherein the imaging optics has a field-of-view of less than about three inches.

78. The viewer of claim 77, wherein the field-of-view is between about one-half inch and about two inches.

79. The viewer of claim 73, wherein the plurality of illumination sources includes a white light LED.

80. The viewer of claim 73, wherein the plurality of illumination sources includes an infrared LED.

81. The viewer of claim 73, wherein the plurality of illumination sources are disposed about a circumference of the optical aperture.

82. The viewer of claim 73, further comprising at least one filter removably disposed so as to cover the optical aperture and the plurality of illumination sources.

83. The viewer of claim 82, wherein the at least one filter includes at least one color filter removably fastenable to the housing to cover at least one of the illumination sources to alter the spectral response, and at least one color filter removably fastenable to the housing to cover the optical aperture.

84. The viewer of claim 82, wherein the at least one filter is adapted for fluorescence imaging.

85. The viewer of claim 84, wherein the at least one filter includes a cobalt blue filter disposed over the illumination source and a Wratten yellow filter disposed over the optical aperture.

86. The viewer of claim 73, further comprising image transfer circuitry configured to communicate the image captured by the image sensor in a wireless manner.

87. The viewer of claim 73, wherein the part of the body is a human eye, and further comprising a built-in light meter adapted to measure an ambient light level at the eye.

88. The viewer of claim 87, wherein the light meter measures luminance from the eye.

89. The viewer of claim 73, further comprising a level sensor configured to measure the orientation of the housing.

90. The viewer of claim 89, wherein the level sensor is a tilt sensor.
